(19) United States
(12) Patent Application Publication
(10) Pub. No.: US 2014/0259823 A1
(43) Pub. Date: Sep. 18, 2014

(54) Undulating Tunnel of Water Streams

(71) Applicants: Mark Fuller, Sun Valley, CA (US); Jules Moretti, Sun Valley, CA (US); Peter Kopik, Sun Valley, CA (US)

(72) Inventors: Mark Fuller, Sun Valley, CA (US); Jules Moretti, Sun Valley, CA (US); Peter Kopik, Sun Valley, CA (US)

(21) Appl. No.: 14/211,941

(22) Filed: Mar. 14, 2014

Related U.S. Application Data
(60) Provisional application No. 61/799,185, filed on Mar. 15, 2013.

(51) Int. Cl. G09F 19/00

(52) U.S. Cl. CPC G09F 19/00
USPC 40/406

(57) ABSTRACT

A water display is described having multiple water delivery devices that create laminar streams with parabolic trajectories. The water delivery devices may modulate the streams, which may be lit, creating individual water arches, that when combined with multiple water delivery devices, can produce dramatic visual effects including the appearance of an undulating and/or pulsed water tunnel.

### CROSS REFERENCE TO RELATED APPLICATION

The application claims the benefit of U.S. Provisional Application No. 61/799,185, filed Mar. 15, 2013, the contents of which are incorporated herein by reference.

### FIELD OF THE INVENTION

The present invention generally relates to water displays, including displays that involve a number of water delivery devices that may provide water streams and that may be controlled in a coordinated manner. To this end, the present invention may provide visual effects such as moving art in the form of water arches and/or tunnels.

### BACKGROUND OF THE INVENTION

Various water displays exist. However, the manner in which multiple streams of water may interact with each other in such displays may be limited. For example, the use of multiple streams of water to create the appearance of undulating arches or tunnels has not occurred.

Accordingly, there is a need for innovative techniques in which water streams may interact to create a visual tunnel that may undulate in a wave-like motion across multiple streams to provide visual effects. These and other issues are addressed by the current invention described herein.

### SUMMARY OF THE INVENTION

In an aspect of the invention, a number of water streams may be positioned near each other and may interact with each other to construct a larger, overall water form. To this end, a number of water delivery devices or nozzles may be positioned near each other in a line, and each device may deliver a stream of water. The streams may be parabolic so that a number of parabolic streams may exist one after the other. In this manner, the number of parabolic streams may resemble a tunnel. The water streams may be laminar.

In another aspect of the invention, each parabolic stream may be varied. For example, the height of each parabolic stream may be varied and this height variation may extend down the line of parabolic water stream to provide the appearance that the tunnel is undulating. Alternatively, the parabolic streams may be selectively or successively turned off and on.

In another aspect of the invention, the nozzles or water delivery devices may be stationary but their parabolic streams may still be varied by varying the flow or velocity of water shot out by the respective water delivery devices. Alternatively, the nozzles or water delivery devices may have some degree of movement. For example, these devices may pivot up and down and/or may rotate laterally. This allows water delivery devices to vary the height of the parabolic stream as well as its direction.

In another aspect of the invention the water delivery devices may be mounted just below the surface of the ground or in a water filled reservoir such as a fountain. The lighting component may comprise an array of lights, such as LEDs, that may turn on and off randomly or in a programmed fashion.

### BRIEF DESCRIPTION OF THE DRAWINGS

FIG. 1 is a perspective view of a stationary nozzle water display.

FIG. 2 is a side view of a stationary nozzle.

FIG. 3 is a perspective view of a radial moving nozzle water display.

FIG. 4 is a side view of a radial moving nozzle.

FIG. 5 is a perspective view of a lateral moving nozzle water display.

FIG. 6 is a side view of a lateral moving nozzle.

FIGS. 7A-7SS are a series of pictures of a water display in operation.

FIG. 8 is a top view of water shooting devices located on a track system.

FIG. 9 is a side view of water shooting devices located on an elevator system.

### DETAILED DESCRIPTION OF THE PREFERRED EMBODIMENTS

The display 10 of the current invention and the visual effects that it may produce are now described with reference to the figures. Where the same or similar components appear in more than one figure, they are identified by the same reference numeral. The invention is described herein with reference to water. However, other liquids and combinations thereof are within the scope of the invention. Furthermore, the invention is described herein with reference to LED lighting though other types of light sources may be used. Display 10 may provide dramatic visual effects by creating an undulating tunnel comprising a number of laminar parabolic streams of water.

As shown in FIG. 1, display 10 may include a number of streams 32 of water which may resemble arches 34. It is preferred that water streams 32 are parabolic. As shown, arches 34 may be positioned one after another so as to collectively provide the appearance of a tunnel 36. Water streams 32 may be provided by water delivery devices or nozzles 30 (not shown in FIG. 1). In the embodiment of FIG. 1, nozzles 30 may be located underneath the floor of display 10 so as to be out of sight to the observer. This may provide a sleek appearance as it may appears that water is simply coming out of the floor. Display 10 may also include a catch basin or other area located where streams 32 come back to the ground to receive the water shot from nozzles 30.

Nozzles 30 may preferably each provide a laminar stream of water 32 in a parabolic trajectory to resemble an arch 34. It is preferred that streams 32 are laminar. An example of a water delivery device or nozzle is more fully described in U.S. Provisional Application Ser. No. 61/739,667, filed Dec. 19, 2012, the contents of which are expressly incorporated by reference as if fully set forth herein. Other water delivery devices 30 that may be used in display 10 are described in: Making Water Dance, Jan. 9, 2003, Machine Design.com. The article may be found at: http://machinedesign.com/article/making-water-dance-0109, and its contents are expressly incorporated by reference as if fully set forth herein.

Nozzles 30 may be positioned as shown in FIG. 2. That is, they may be located under the floor but may shoot water through an opening in the floor. Nozzles 30 may be oriented so that water stream 32 leaves nozzle 30 at a certain angle. In this embodiment, nozzles 30 may be stationary. Accordingly, the angle at which nozzles 30 are oriented is preferably determined based on the desired size height and width of tunnel 36 and the overall size of display 10.

Display 10 of the current invention may be installed in a number of locations such as a sidewalk, as an indoor or outdoor water fountain or pool, building lobbies, banquet halls or rooms, or any other location that may be used for observing a water display.

As mentioned above, the height of the parabolic streams 32 may be varied. In the embodiment where nozzles 30 are stationary, height adjustment may generally occur by varying the flow or velocity of the water existing nozzles 30. As flow or velocity increases, the height of any given parabolic stream 32 may increase. FIG. 1 shows an example where successive parabolic streams of water 32 are at different heights.

The manner in which display 10 may provide the appearance of an undulating tunnel is now discussed with reference to FIGS. 7A-7AA. As shown by this series of pictures of display 10, the height of streams 32 may be varied in a coordinated manner to provide the undulating appearance. For example, it may appear as if a wave is rolling through tunnel 36. Alternatively, tunnel 36 may appear as if its height is randomly increasing and/or decreasing at various points along its length. As shown in FIG. 7A, all parabolic streams 32 may start out at the same height. Later, however, the height of the nearest stream may increase and this may be followed by increasing the height of consecutive streams 34 as shown through FIG. 7E. At this point, streams 32 in the middle of display 10 may increase in height but at the same time, the streams 32 at the near end of the tunnel 36 may decrease in height. This decrease in height may then make its way down the line.

The height of streams 32 may be successively increased and/or decreased, or a more random pattern of this height adjustment may be used. In any event, FIGS. 7A-7W provide different examples of how stream height may be varied to provide the appearance of an undulating tunnel.

These figures also provide an example of how successive or various streams 32 may be turned off and then back on to provide a pulsed appearance. More specifically, FIGS. 7AA-7SS show how successive or various streams 32 may be turned off and on. As shown, streams 32 may be successively turned off and then turned back going down the line. As an alternative, streams may be turned off and on randomly. It is preferred that nozzles 30 include a fast-acting valve or other device that may shut off the flow of water so that when streams 32 are turned off, they have definitive endpoints as they travel through their parabolic trajectory.

FIG. 3 is a perspective view of another embodiment of display 10. In this embodiment, nozzles 30 may be adjusted radially as shown in FIG. 4. In other words, the angle at which nozzles 30 shoot water into the air may be varied. This may alter the trajectories of the laminar water streams 32 exiting nozzle 30 as shown in FIG. 4. The adjustment of nozzles 30 may be pre-programmed to coordinate with other nozzles 30 in the same display or may be adjusted during downtime in the display to create different effects.

In a preferred embodiment, the flow or velocity of water leaving nozzles 30 may vary with the angle of the nozzle. As shown in FIG. 4, nozzles 30 may be programmed so that regardless of the angle at which they shoot out water, the water may land at about the same distance from the respective shooters. To this end, water velocity may increase where a taller parabolic trajectory is desired.

FIG. 4 shows how streams 32 may vary in height depending on the radial position of nozzle 30. The height of the laminar water streams 32 exiting water shooters 30 may be adjusted by increasing or decreasing the angle between the exiting water stream and ground level, including but not limited to, achieving the appearance of an undulating water tunnel.

FIG. 5 is a perspective view of another embodiment of display 10. In this embodiment, nozzles 30 may move laterally as shown in FIG. 6. In this manner, nozzles 30 may be adjusted to alter the direction of water streams 32 along the length of tunnel 36. Similar to the radially adjustable water shooter 30 described above, laterally adjustable nozzle 30 may be pre-programmed to effectuate a variety of water effects. In this embodiment, the direction of streams 32 may be altered so as to provide the appearance that a wall of tunnel 36 is opening as shown in FIG. 5.

FIG. 6 shows the laterally adjustable water delivery device or nozzle 30 in more detail. In this embodiment, the horizontal direction of the laminar water streaming exiting nozzles 30 may be adjusted to provide various display effects, including but not limited to, achieving the appearance of an undulating water tunnel. One or more laterally adjustable nozzles 30 may be combined to effectuate a display 10 with water streams that cross or change the landing positions of the water streams while still providing undulating tunnel effects. This type of nozzle 30 may rotate about a central axis when it moves laterally.

Display 10 may further be modified by locating water delivery devices or nozzles 30 on track 50 as shown in FIG. 8. Track 50 may comprise various assemblies including a means to mount nozzles 30 to track 50. Track 50 may be used to physically move one or more nozzles 30 horizontally during a water display performance or to aid in transporting nozzles 30 after a performance if the display 10 is portable. Nozzles 30 coupled to track 50 may still be combined to effectuate display 10 with arches and tunnels.

Display 10 may further be modified by locating water delivery devices or nozzles 30 on elevator 70 as shown in FIG. 8. Elevator 70 may comprise various assemblies including a means to mount nozzles 30 to respective elevator platforms 70. Elevator 70 may be used to move one or more nozzles 30 vertically during a water display or to change locations of nozzles 30 after a display. Similar to track 50, nozzles 30 fixed to elevator 70 may be combined to effectuate display 10 with arches and tunnels.

Display 10 may incorporate one or more of the embodiments listed above in a single display so that stationary, radially adjustable and laterally adjustable nozzles 30 may comprise a single display 10. This may further enhance the artistic capabilities of display 10. Furthermore the streams may be perpendicular to the longitudinal axis of tunnel 36 or at an angle thereto. Tunnel 36 may be configured to be a straight or curve line.

Although certain presently preferred embodiments of the invention have been described herein, it will be apparent to those skilled in the art to which the invention pertains that variations and modifications of the described embodiments may be made without departing from the spirit and scope of the invention.

What is claimed is:

1. A water display, comprising:
a plurality of water delivery devices that are successively positioned and that provide successive streams of water;
wherein the successive streams of water form a tunnel; and
wherein the height of at least some of the successive streams of water may be varied.

2. The display of claim 1 wherein the water streams are parabolic.

3. The display of claim 1, wherein the water streams are laminar.

4. The display of claim 1, wherein the water delivery devices are stationary.

5. The display of claim 1, wherein the water delivery device are configured to move radially.

6. The display of claim 1, wherein the water delivery devices are configured to move laterally.

7. The display of claim 1 wherein at least some of the successive streams of water are turned off and on.

8. The display of claim 1 wherein at least some of the water delivery devices are mounted to a track.

9. The display of claim 1 wherein at least some of the water delivery devices are mounted to an elevator.
